(19) United States
(12) Patent Application Publication
(10) Pub. No.: US 2008/0263472 A1
(43) Pub. Date: Oct. 23, 2008

(54) Interactive ticker

(75) Inventors: Vivek Thukral, Palo Alto, CA (US); Jon Conradt, San Jose, CA (US); Eric Soldan, Redmond, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/788,135

(22) Filed: Apr. 19, 2007

(51) Int. Cl. G06F 3/048

(52) U.S. Cl. 715/774

(57) ABSTRACT

An interactive ticker is described. In embodiment(s), an interactive ticker can be displayed to include selectable ticker data that can be selected by a viewer. The interactive ticker can be displayed over and/or with television media content that is also being displayed for viewing. In addition, a control input can be received to configure the interactive ticker for display.

### BACKGROUND

Tickers are electronic messages displayed across a display screen, such as during a news broadcast or sports information program. A news ticker may include a breaking news story, stock quotes, a list of headline stories, and/or other news information. A sports ticker may include contest scores, upcoming game schedules, sports news stories, and/or other sporting information. The information included in a ticker display is provided to subscribers' television client devices via a data broadcast from a content distributor. Current television ticker displays are simply displayed as the data is received along with an associated television channel, irrespective of whether a viewer may want a ticker display while viewing the television channel.

### SUMMARY

This summary is provided to introduce simplified concepts of interactive ticker. The simplified concepts are further described below in the Detailed Description. This summary is not intended to identify essential features of the claimed subject matter, nor is it intended for use in determining the scope of the claimed subject matter.

In embodiment(s), an interactive ticker can be displayed to include selectable ticker data that can be selected by a viewer. The interactive ticker can be displayed over and/or with television media content that is also being displayed for viewing. In addition, a control input can be received to configure the interactive ticker for display.

In other embodiment(s), the selectable ticker data displayed in the interactive ticker can include favorite channels of a viewer, and the favorite channels can each be displayed as a picture-in-picture in the interactive ticker. A viewer selection of a picture-in-picture can initiate the corresponding favorite channel being displayed for viewing as the television media content. The selectable ticker data can also include buddies that are associated with the viewer in a buddy list, and a viewer selection can initiate instant messaging communication with one or more of the buddies displayed in the interactive ticker. The selectable ticker data can also include computer applications that are selectable from the interactive ticker, and a viewer selection can initiate a computer application for viewer interaction.

In other embodiment(s), control inputs can be received to configure the interactive ticker. The control inputs can include a selection of the type of selectable ticker data that is displayed in the interactive ticker, such as ticker data that corresponds to a viewer. Other control inputs can be received to initiate scrolling the interactive ticker in a horizontal (i.e., left or right), vertical (i.e., up or down), or reverse direction. A selectable control input can also initiate any one of starting the interactive ticker, stopping the interactive ticker, turning the interactive ticker on for display, or turning the interactive ticker off. Additionally, an interactive ticker can be initiated to display automatically, such as at a designated time of day, when the ticker data corresponds to a particular television program, and/or based on any other type of display triggers that initiate an interactive ticker for display.

### BRIEF DESCRIPTION OF THE DRAWINGS

Embodiments of interactive ticker are described with reference to the following drawings. The same numbers are used throughout the drawings to reference like features and components:

FIG. 1 illustrates an example system in which embodiments of interactive ticker can be implemented.

FIG. 2 illustrates another example system in which embodiments of interactive ticker can be implemented.

FIG. 3 illustrates an example television client system in which embodiments of interactive ticker can be implemented.

FIG. 4 illustrates example method(s) for an interactive ticker in accordance with one or more embodiments.

FIG. 5 illustrates example method(s) for an interactive ticker in accordance with one or more embodiments.

FIG. 6 illustrates various components of an example client device which can implement embodiments of an interactive ticker.

FIG. 7 illustrates various devices and components in an example entertainment and information system in which embodiments of interactive ticker can be implemented.

### DETAILED DESCRIPTION

Embodiments of an interactive ticker provide that a viewer can customize and control the display of an interactive ticker on a display device, as well as select the type of ticker data that is displayed. In one embodiment, the selectable ticker data can include the favorite channels of a viewer each displayed as a picture-in-picture in the interactive ticker. A viewer selection of a picture-in-picture initiates the corresponding favorite channel being displayed full-size on the display device. An interactive ticker also provides that a viewer can select to display various types of personal data in the ticker display and control the format of that data within the ticker media stream.

While features and concepts of the described systems and methods for an interactive ticker can be implemented in any number of different environments, computing systems, entertainment systems, and/or other various configurations, embodiments of an interactive ticker are described in the context of the following example systems and environments.

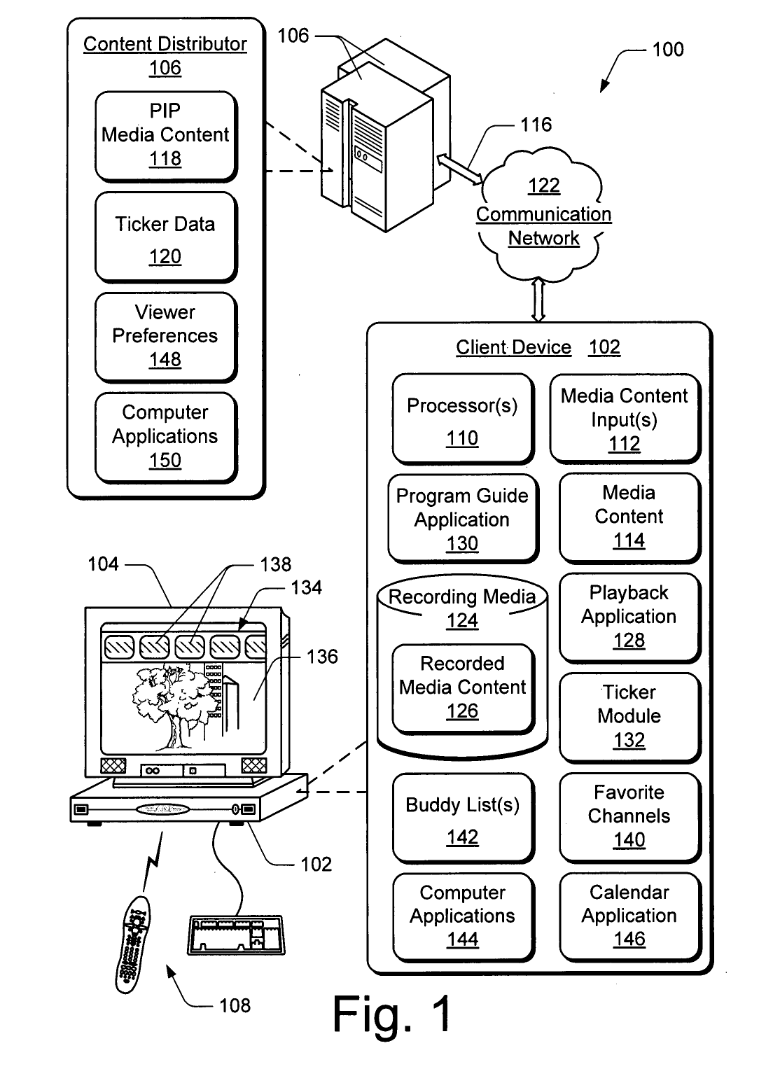

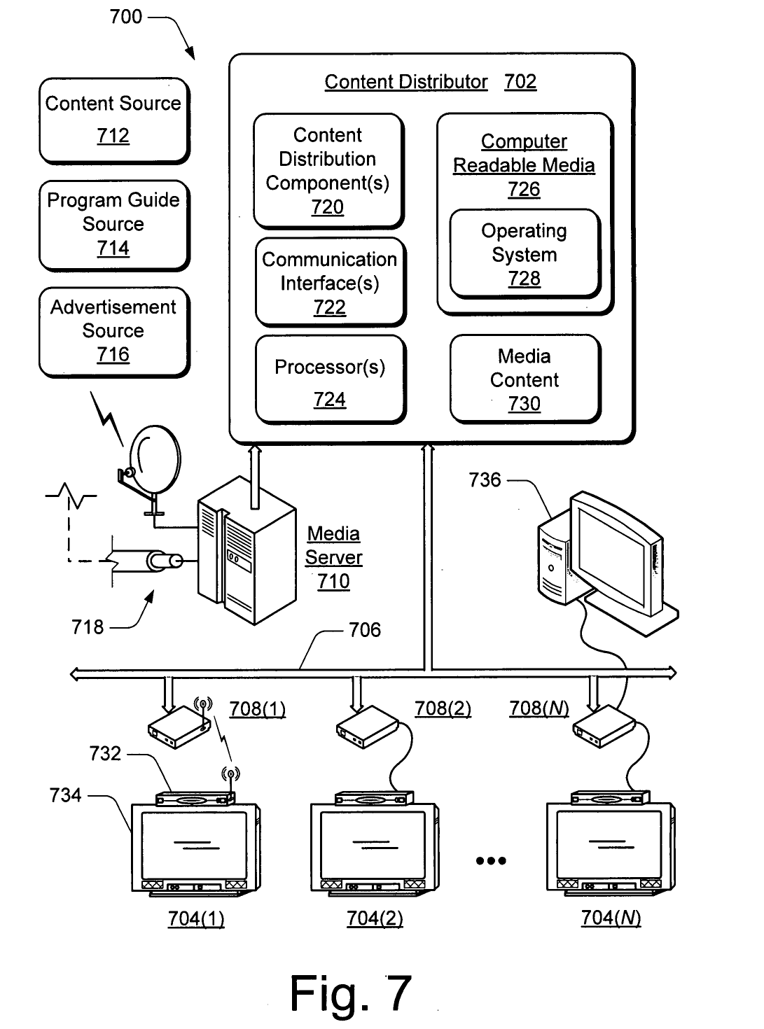

FIG. 1 illustrates an example system 100 in which various embodiments of an interactive ticker can be implemented. In this example, system 100 includes a television client device 102, a display device 104, content distributor(s) 106, and input devices 108, such as a remote control device and/or a computer keyboard. The display device 104 can be implemented as any type of television, LCD, or similar television-based display system that renders audio, video, and/or image data. The client device 102 and display device 104 together are just one example of a television client system, examples of which are described with reference to the example entertainment and information system shown in FIG. 7.

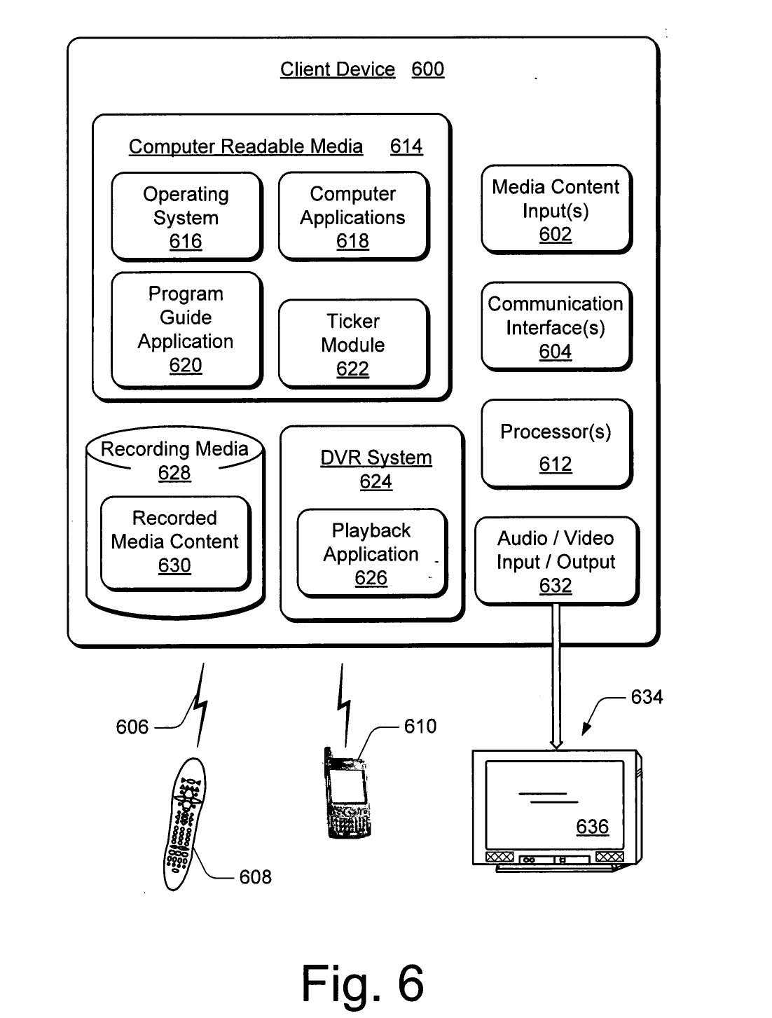

Client device 102 can be implemented as any one or combination of a television set-top box, a digital video recorder (DVR) and playback system, an appliance device, a gaming console, and/or as any other type of television client device or computing-based device that may be implemented in a television entertainment and information system. Additionally, client device 102 can be implemented with any number and combination of differing components as further described with reference to the example client device shown in FIG. 6.

In this example system 100, client device 102 includes one or more processor(s) 110, media content inputs 112, and media content 114 (e.g., received media content or media content that is being received). The media content inputs 112 can include any type of Internet Protocol (IP) inputs over which streams of media content (e.g., IPTV media content) are received. Client device 102 can receive the media content 114 from any one or combination of content distributor(s) 106 via an IP-based network 116. The media content 114 can include television media content for a full-size television display as well as separate media streams of picture-in-picture media content 118 received from a content distributor 106. In addition, the media content 114 can include ticker data 120 received from the content distributor(s) 106. For example, ticker data 120 can be received at client device 102 as a ticker feed that includes news headlines, stock quotes, sports scores, local traffic information, and/or any other information associated with a television channel or channels.

The IP-based network 116 can be implemented as part of a communication network 122 that facilitates media content distribution and data communication between the content distributor(s) 106 and any number of client devices, such as client device 102. The communication network 122 can be implemented as part of a media content distribution system using any type of network topology and/or communication protocol, and can be represented or otherwise implemented as a combination of two or more networks. The television client device 102 is configured for communication with the content distributor(s) 106 via the IP-based network 116 and/or the communication network 122.

Client device 102 also includes recording media 124 that maintains recorded media content 126. In an embodiment, the recorded media content 126 can include the media content 114 that is received from a content distributor 106 and recorded. For example, the media content 114 can be recorded when received as a viewer-scheduled recording, or when the recording media 124 is a pause buffer that records the media content 114 as it is being received and rendered for viewing.

The recording media 124 along with a playback application 128 can be implemented as a DVR (digital video recorder) system to record and maintain the recorded media content 126. The media content 114 and/or the recorded media content 126 can include television programs (or programming) which may be any form of programs, commercials, music, movies, and video on-demand media content. Other media content can include interactive games, network-based applications, music streamed from a computing device to the client device 102, as well as any other audio, video, and/or image content received from any type of media content source.

Client device 102 includes a program guide application 130 that processes program guide data from which a program guide can be rendered and displayed for viewing on display device 104. A program guide is also commonly referred to as an electronic program guide or an “EPG”. A viewer can navigate a program guide utilizing an input device 108, such as the remote control.

Client device 102 also includes a ticker module 132 that processes ticker data 120 received from content distributor(s) 106 as well as implements embodiments of an interactive ticker. The ticker module 132 can generate an interactive ticker 134 which can be displayed for viewing on display device 104. The playback application 128, program guide application 130, and ticker module 132 can each be implemented as computer-executable instructions and executed by the processor(s) 110 to implement embodiments of an interactive ticker.

In this example system 100, the interactive ticker 134 is displayed horizontally along with and/or over a full-size display of a television program 136. However, the display of the interactive ticker 134 on display device 104 is merely exemplary. In various embodiments, the ticker module 132 can be implemented to generate a horizontal display of an interactive ticker that can scroll left or right, a vertical display of an interactive ticker that can scroll up or down, and to display the ticker at the at the top, bottom, left, or right of the display device, and/or in any other position, size, and/or display configuration.

The interactive ticker 134 includes data positions 138 that are each a placeholder for selectable ticker data displayed in the interactive ticker 134. The selectable ticker data can include any one or combination of text, images, selectable links, and/or video streams. Examples of selectable ticker data that can be selected by a viewer from a data position 138 includes favorite channels 140. In an embodiment, the viewer's favorite television channels can each be displayed as a picture-in-picture in a data position 138 in the interactive ticker 134. Alternatively, or in addition, the favorite channels 140 can each be displayed in the interactive ticker 134 as any combination of video or images.

In other embodiments, the selectable ticker data that can be selected by a viewer from a data position 138 includes “buddies” that are associated with the viewer in a buddy list 142. A viewer may select one of the “buddies” from a data position 138 to initiate an instant messaging application for instant messaging communication with the selected buddy. Alternatively, or in addition, the television program(s) that a buddy is currently viewing may be displayed as the selectable ticker data along with buddy identifiers in the interactive ticker 134. The selectable ticker data may also include a list of computer applications 144 that are each selectable from a data position 138 to initiate a computer application being displayed on the display device 104 for viewer interaction. The computer applications 144 can include the instant messaging application, a Web browser, a program guide, a calendar application 146, or any other computer applications that can be launched from the interactive ticker 134 for viewer interaction via an input device 108, such as the television remote control.

In an alternate embodiment, the selectable ticker data may also include any data selected for display by a viewer, such as upcoming calendar events scheduled in the calendar application 146, stock quotes and pricing specific to a portfolio of the viewer, or sports scores for local teams. In an implementation, the ticker module 132 can filter the ticker data 120 received from a content distributor 106 to display the stock information specific to the viewer, or to display the local sports scores. The selectable ticker data can also include instant message displays, the caller IDs for missed calls, or other local information such as school lunch menus and school closure reminders which may be received as RSS-format (Really Simple Syndication) ticker data 120.

In other embodiments, the selectable ticker data may also include, or be implemented for, alarms that display automatically for calendar events such as to pick up the kids, stock price alarms for declining shares or sales points, and any other viewer personal content. In addition, the selectable ticker data displayed in the interactive ticker 134 can be modified based on a time of the day in which the ticker data is displayed. For example, the interactive ticker 134 may be configured by the viewer to display traffic and/or weather information in the morning before going off to work, and then to display sports scores and/or the viewer's favorite television channels 140 in the evening after work.

In another embodiment, an interactive ticker can be initiated to display automatically based on any one or more display triggers. An interactive ticker can be automatically turned-on and/or the selectable ticker data displayed in the ticker can be automatically changed to a different type of ticker data based on the trigger(s). For example, the interactive ticker 134 can be implemented to turn-on for display at a designated time of the day or within any specified range of time. Further, the interactive ticker 134 can be implemented to turn-on based on the particular type of television program 136 that is being displayed for viewing. For example, if the television program 136 is a news program, then the interactive ticker 134 can turn-on and include news related ticker data, such as breaking news stories or a list of headline stories. The ticker module 132 can also be implemented to monitor the various ticker data and then initiate a display of the interactive ticker 134 when the ticker data changes. For example, the interactive ticker 134 can be initiated to turn-on and display weather related information for a viewer's particular region when the weather forecast changes.

If the television program 136 is a sports show, then the interactive ticker 134 can be initiated to turn-on and include sports related ticker data such as contest scores, game schedules, and/or other sporting information. If the television program 136 is a financial-related program, then the interactive ticker 134 can be initiated to turn-on and include stock quotes and pricing information. Further, as the ticker module 132 monitors the ticker data, the interactive ticker 134 can be initiated to turn-on and display stock quotes and pricing specific to a portfolio of the viewer if the stock prices decline or increase by a designated or preset amount. In the embodiments, the interactive ticker 134 can be initiated to turn-on and display selectable ticker data that is associated with the television program 136 and/or turn-on and display ticker data that changes irrespective of the content of the television program 136. For example, the viewer may want to be informed of a weather forecast change or a change in a stock price at any time, and not just when watching a news or financial program.

In another embodiment of interactive ticker, a viewer at client device 102 may input search criteria with an input device 108, such as with the remote control or keyboard. The viewer may interact with the client device 102 to initiate a program guide search, an Internet search, or a search for products and/or services shown on the display device 104 in the form of an advertisement.

In an alternate embodiment of the example system 100, a content distributor 106 can include viewer preferences 148 rather than, or in addition to the favorite channels 140 and the buddy list(s) 142 at client device 102. Further, the content distributor 106 can include computer applications 150 rather than, or in addition to the computer applications 144 at client device 102. For example, a viewer may select a “buddy” from a data position 138 in the interactive ticker 134 to initiate an instant messaging application at content distributor 106 (e.g., a computer application 150) for instant messaging communication with the selected buddy. Further, a viewer may launch a computer application 150 at the content distributor 106, such as an instant messaging application, a Web browser, a program guide, a calendar application, or any other computer applications 150 that can be launched from the interactive ticker 134.

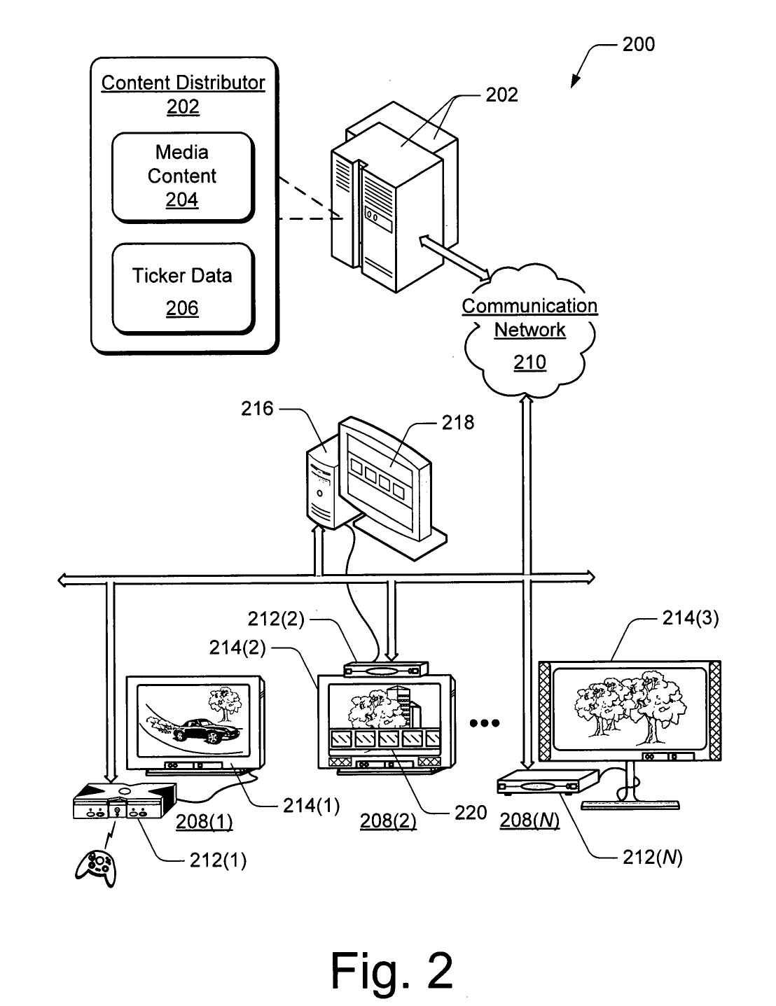

FIG. 2 illustrates another example system 200 in which various embodiments of an interactive ticker can be implemented. The system 200 includes content distributor(s) 202 that communicate media content 204 and ticker data 206 to any number “N” of various television client systems 208(1-N) via a communication network 210. An example of a communication network is described with reference to communication network 122, and examples of client devices in television client systems are described with reference to television client device 102 shown in FIG. 1. The communication network 210 can be implemented to include an IP-based network that facilitates media content distribution and data communication between the content distributor(s) 202 and any number of television client devices.

Each of the client systems 208(1-N) include a respective television client device 212(1-N) and a respective display device 214(1-N), such as any type of television, monitor, LCD, or similar television-based display system that renders audio, video, and/or image data. Any of the client devices 212(1-N) can be implemented as any one or combination of a television client device, a gaming system, or as any other computing-based device, such as a desktop computer, a portable computer, a television set-top box, a digital video recorder (DVR), an appliance device, a gaming console, and/or as any other type of computing-based client device. Any of the television client devices 212(1-N) may also be associated with a user (i.e., a person) and/or an entity that operates a client device such that a television client device describes logical clients that include users, software, and/or devices.

Any of the television client devices 212(1-N) of the respective client systems 208(1-N) can be implemented with one or more processors, a communication module, memory components, a media content rendering system, and a ticker module to implement embodiments of an interactive ticker. Additionally, each of the television client devices 212(1-N) can be configured for communication with any number of different content distributors 202 to receive any type of media content 204 and the ticker data 206 via the communication network 210. Further, any of the television client devices 212(1-N) can be implemented with any number and combination of differing components as further described with reference to the example client device shown in FIG. 6.

In this example, client device 212(2) is a television set-top box that is connected, or otherwise communicatively linked, to a computing device 216 that can be implemented to generate a ticker configuration interface 218. Interactive ticker(s) can be configured for display via the ticker configuration interface 218, such as interactive ticker 220 displayed on display device 214(2) of client system 208(2). The computing device 216 can also be configured for communication with a content distributor 202 to receive the ticker data 206 via the communication network 210.

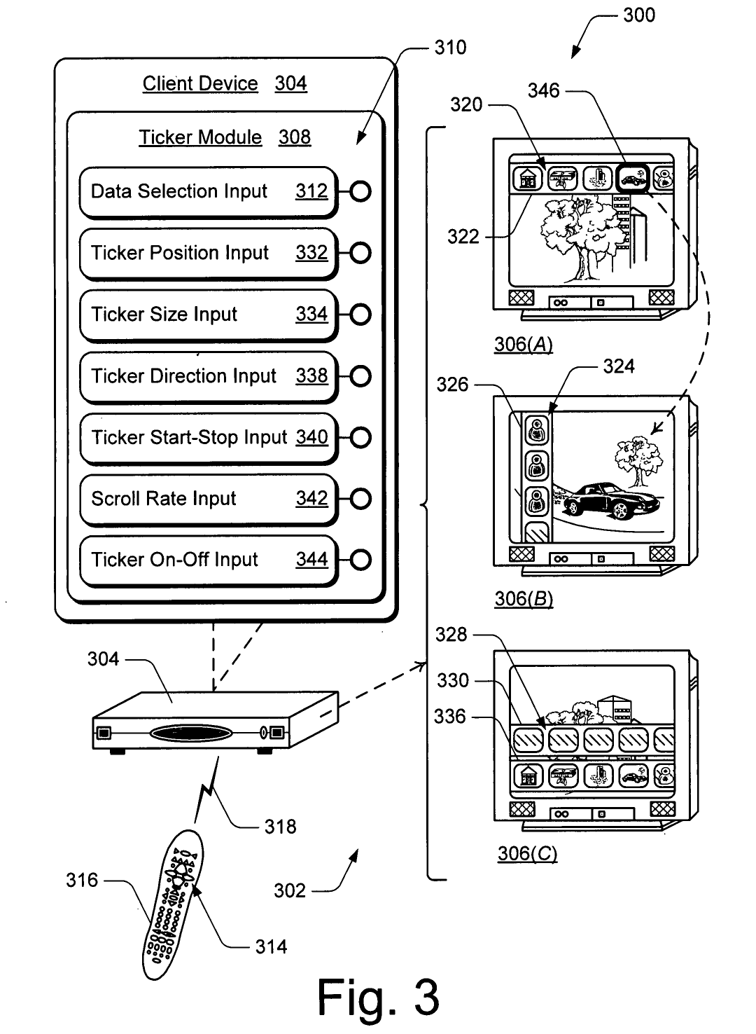

FIG. 3 illustrates an example 300 of a television client system 302 that includes a television client device 304 and different representations of a display device 306(A-C) to illustrate various embodiments of an interactive ticker. The client device 304 includes a ticker module 308 that has ticker configuration and/or control inputs 310 for configuring an interactive ticker when displayed with television media content. An example of a ticker module is further described with reference to ticker module 132 shown in FIG. 1 to implement embodiments of an interactive ticker.

In this example 300, the ticker configuration and/or control inputs 310 include a data selection input 312 such that a viewer at client device 304 can select a type of the selectable ticker data that is displayed in an interactive ticker. A viewer can manipulate selectable input controls 314 of a remote control input device 316 via which the viewer can input control commands 318 to the client device 304. For example, a viewer can initiate a data selection input 312 to select favorite channels 320 each being displayed as a picture-in-picture in an interactive ticker 322 shown on display device 306(A). In another embodiment, a viewer can choose selectable ticker data that includes buddies 324 associated with the viewer in a buddy list and displayed in an interactive ticker 326 shown on display device 306(B).

In other embodiments, a viewer can choose selectable ticker data via data selection input 312 that includes a list of computer applications, calendar events and/or event alarms, stock quotes specific to the viewer's portfolio, headline news items, sports scores, instant messages, caller IDs for missed calls, local school information, traffic information, weather information, Internet search results, television program guide search results, and/or any other viewer specific content that is any combination of audio, video, and/or image content. In one example, the selectable ticker data is recorded programs 328 that are selectable for viewing from an interactive ticker 330 shown on display device 306(C). Further, an interactive ticker having any one or combination of the different types of selectable ticker data can be displayed on, over, or with television media content from any television channel.

The different representations of display device 306(A-C) illustrate various embodiments of interactive tickers. An interactive ticker can be displayed at any position on a display device, and can be configured for any size. The ticker configuration and/or control inputs 310 include a ticker position input 332 and a ticker size input 334 such that a viewer at client device 304 can select a position on the display device for the interactive ticker to display, and can select a size of the interactive ticker. For example, interactive ticker 322 can be selected for display as a horizontal ticker at or near the top of display device 306(A). Alternatively, an interactive ticker can be selected for a position at or near the bottom of a display device, such as interactive ticker 336 shown on display device 306(C).

In another example of a ticker position input 332, interactive ticker 326 can be selected for display as a vertical ticker at or near the left side of display device 306(B). Alternatively, an interactive ticker can be selected for a position at or near the right side of the display device. In addition, one or more interactive tickers can be displayed together on a display device, such as interactive tickers 330 and 336 displayed on display device 306(C).

The ticker configuration inputs 310 also include a ticker direction input 338 and a ticker start-stop input 340 such that a viewer at client device 304 can select or change a scrolling direction of an interactive ticker, and whether the interactive ticker scrolls across the display or is stopped from scrolling. For example, interactive ticker 322 can be selected to scroll left, right, or in a reverse direction (i.e. reverse to scroll left if scrolling right, and vice-versa). In another example, interactive ticker 326 can be selected to scroll up, down, or in a reverse direction (i.e. reverse to scroll down if scrolling up, and vice-versa).

In this example 300, the ticker configuration and/or control inputs 310 also include a scroll rate input 342 such that a viewer at client device 304 can set or adjust the rate of scroll for an interactive ticker displayed on a display device. The ticker configuration and/or control inputs 310 also include a ticker on-off input 344 such that a viewer at client device 304 can turn an interactive ticker display on or off. Alternatively, the ticker on-off input 344 can be controlled by the ticker module 308 to initiate automatically displaying an interactive ticker. An interactive ticker can be automatically turned-on and/or the selectable ticker data displayed in the ticker can be automatically changed to a different type of ticker data based on any one or combination of display triggers, such as described with reference to ticker module 132 and interactive ticker 134 shown in FIG. 1.

This example 300 also illustrates a “smart channel change” from a picture-in-picture of a favorite channel displayed in an interactive ticker. The interactive ticker 322 includes data positions that are placeholders for each picture-in-picture that represents a favorite channel 320 of the viewer. The interactive ticker 322 can include a selectable control 346 shown implemented as an on-screen focus that can be positioned to select a favorite channel 320 and, when selected, initiate the favorite channel being displayed as the full-size television media content on display device 306(B) (e.g., the transition is illustrated by the selection at display device 306(A) being displayed on display device 306(B)). The viewer can move the selectable control 346 within the interactive ticker 322 and select the various favorite channels 320 from the data positions by manipulating the remote control input device 316.

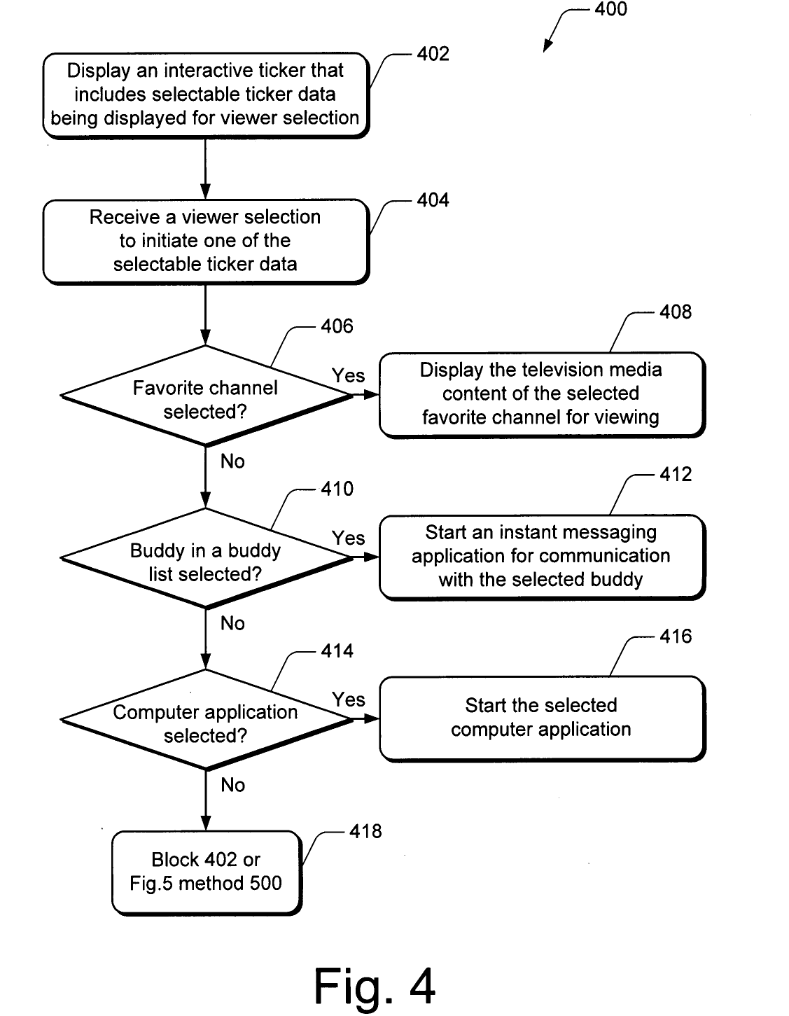

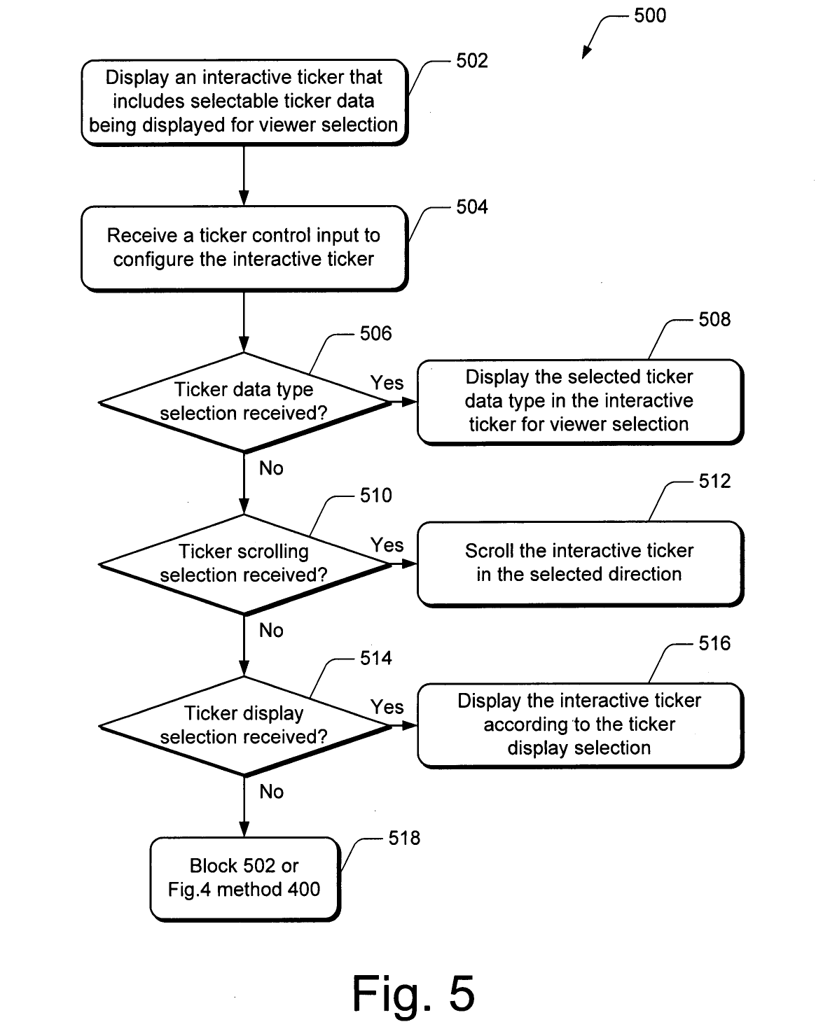

Generally, any of the functions, methods, and modules described herein can be implemented using hardware, software, firmware (e.g., fixed logic circuitry), manual processing, or any combination thereof. A software implementation of a function, method, or module represents program code that performs specified tasks when executed on a computing-based processor. Example methods 400 and 500 described with reference to respective FIGS. 4 and 5 may be described in the general context of computer-executable instructions. Generally, computer-executable instructions can include applications, routines, programs, objects, components, data structures, procedures, modules, functions, and the like that perform particular functions or implement particular abstract data types. The method(s) may also be practiced in a distributed computing environment where functions are performed by remote processing devices that are linked through a communications network. In a distributed computing environment, computer-executable instructions may be located in both local and remote computer storage media, including memory storage devices. Further, the features described herein are platform-independent such that the techniques may be implemented on a variety of computing platforms having a variety of processors.

FIG. 4 illustrates example method(s) 400 of an interactive ticker. The order in which the method is described is not intended to be construed as a limitation, and any number of the described method blocks can be combined in any order to implement the method, or an alternate method.

At block 402, an interactive ticker is displayed that includes selectable ticker data being displayed for viewer selection. For example, interactive ticker 322 (FIG. 3) includes favorite channels 320 of a viewer, and the favorite channels 320 are each displayed as a picture-in-picture in the interactive ticker. In another example, interactive ticker 326 includes buddies 324 that are associated with the viewer in a buddy list. In another example, an interactive ticker can include computer applications that are selectable from the interactive ticker to launch a computer application.

At block 404, a viewer selection is received to initiate one of the selectable ticker data. At block 406, a determination is made as to whether the received viewer selection is a favorite channel. If the viewer selection is a favorite channel (i.e., “Yes” from block 406), then the television media content corresponding to the selected favorite channel is displayed for viewing at block 408. For example, interactive ticker 322 includes pictures-in-picture that each represent a favorite channel 320 of the viewer. When a viewer selects a favorite channel 320 at display device 306(A), the favorite channel is displayed as the full-size television media content on display device 306(B) (e.g., the transition is illustrated by the selection at display device 306(A) being displayed on display device 306(B)).

If the viewer selection is not a favorite channel (i.e., “No” from block 406), then at block 410, a determination is made as to whether the viewer selection is a buddy listed in a buddy list. If the viewer selection is a buddy (i.e., “Yes” from block 410), then an instant messaging application is started or launched for communication with the selected buddy at block 412. For example, interactive ticker 326 includes buddies 324 that are associated with the viewer in a buddy list. When a viewer selects a buddy 324 from the interactive ticker 326, an instant messaging application is launched for viewer interaction and instant messaging communication with the selected buddy.

If the viewer selection is not a buddy (i.e., “No” from block 410), then at block 414, a determination is made as to whether the viewer selection is a computer application selected from an interactive ticker. If the viewer selection is a computer application (i.e., “Yes” from block 414), then the selected computer application is started, or launched at block 416. For example, interactive ticker 134 (FIG. 1) can include computer applications 144 listed in the data positions 138, and the viewer can start or launch any type of computer application for viewer interaction by selecting from the interactive ticker. If the viewer selection is not a computer application (i.e., “No” from block 414), then at block 418, the method 400 can continue at any of the method blocks 402-416 and/or begin method 500 at any of the method blocks 502-516 described with reference to FIG. 5.

FIG. 5 illustrates example method(s) 500 of an interactive ticker. The order in which the method is described is not intended to be construed as a limitation, and any number of the described method blocks can be combined in any order to implement the method, or an alternate method.

At block 502, an interactive ticker is displayed that includes selectable ticker data being displayed for viewer selection. For example, interactive ticker 322 (FIG. 3) includes favorite channels 320 of a viewer, and the favorite channels 320 are each displayed as a picture-in-picture in the interactive ticker. In other examples, interactive ticker 326 includes buddies 324 that are associated with the viewer in a buddy list, or an interactive ticker can include computer applications that are selectable to start or launch a computer application.

At block 504, a ticker control input is received to configure the interactive ticker. At block 506, a determination is made as to whether the received control input is a data type selection. If the control input is a data type selection (i.e., “Yes” from block 506), then the selected ticker data type is displayed in the interactive ticker for viewer selection at block 508. For example, a viewer can initiate a data selection input 312 (FIG. 3) to select favorite channels 320 each being displayed as a picture-in-picture in an interactive ticker 322 shown on display device 306(A). In another embodiment, a viewer can choose selectable ticker data that includes buddies 324 associated with the viewer in a buddy list and displayed in an interactive ticker 326 shown on display device 306(B).

In other embodiments, a viewer can choose selectable ticker data via data selection input 312 that includes a list of computer applications, calendar events and/or event alarms, stock quotes specific to the viewer's portfolio, headline news items, sports scores, instant messages, caller IDs for missed calls, local school information, traffic information, weather information, Internet search results, television program guide search results, recorded programs, and/or any other viewer specific content that is any combination of audio, video, and/or image content.

If the control input is not a data type selection (i.e., “No” from block 506), then at block 510, a determination is made as to whether the control input is a ticker scrolling selection. If the control input is a ticker scrolling selection (i.e., “Yes” from block 510), then at block 512, the interactive ticker is scrolled in the selected direction according to the control input. A viewer can configure or control an interactive ticker with any one or combination of a ticker direction input 338, a ticker start-stop input 340, and/or a ticker scroll rate input 342. For example, horizontal interactive ticker 322 can be configured to scroll left, right, or in a reverse direction (i.e. reverse to scroll left if scrolling right, and vice-versa). In another example, vertical interactive ticker 326 can be selected to scroll up, down, or in a reverse direction (i.e. reverse to scroll down if scrolling up, and vice-versa). A viewer can also configure the scroll rate of an interactive ticker with a scroll rate input 342.

If the control input is not a ticker scrolling selection (i.e., “No” from block 510), then at block 514, a determination is made as to whether the control input is a ticker display selection. If the control input is a ticker display selection (i.e., “Yes” from block 514), then the interactive ticker is displayed according to the ticker display selection at block 516. For example, a viewer can configure or control an interactive ticker display with any one or combination of a ticker position input 332, a ticker size input 334, and/or a ticker on-off input 344. For example, a viewer at client device 304 can turn an interactive ticker display on or off, select a position on the display device to display the interactive ticker, and select a display size of the interactive ticker. For example, interactive ticker 322 is displayed as a horizontal ticker at or near the top of display device 306(A). Alternatively, an interactive ticker can be selected for a position at or near the bottom of a display device, such as interactive ticker 336 shown on display device 306(C).

In another example of a ticker position input 332, interactive ticker 326 is displayed as a vertical ticker at or near the left side of display device 306(B). Alternatively, an interactive ticker can be selected for a position at or near the right side of the display device. In addition, one or more interactive tickers can be displayed together on a display device, such as interactive tickers 330 and 336 displayed together on display device 306(C).

In another example, ticker module 308 can initiate automatically turning an interactive ticker on for display and/or changing the displayed selectable ticker data based on any one or combination of display triggers. The ticker display selection received at block 514 can be an automatic display trigger received from a ticker module to initiate turning-on an interactive ticker for display and/or to initiate changing the selectable ticker data that is displayed in the interactive ticker. If the control input is not a ticker display selection (i.e., “No” from block 514), then at block 518 the method 500 can continue at any of the method blocks 502-516 and/or begin method 400 at any of the method blocks 402-416 described with reference to FIG. 4.

FIG. 6 illustrates various components of an example client device 600 that can be implemented as any form of a computing, electronic, or television client device to implement embodiments of interactive ticker. For example, client device 600 can be implemented as client device 102 shown in FIG. 1, and/or as any of the client devices 212(1-N) of the client systems 208(1-N) shown in FIG. 2. In various embodiments, client device 600 can be implemented as any one or combination of a television client device, a gaming system, or as any other computing-based device, such as a desktop computer, a portable computer, a television set-top box, a digital video recorder (DVR), an appliance device, a gaming console, and/or as any other type of computing-based client device.

Client device 600 includes one or more media content inputs 602 that may include Internet Protocol (IP) inputs over which streams of media content are received via an IP-based network. Client device 600 further includes communication interface(s) 604 that can be implemented as any one or more of a serial and/or parallel interface, a wireless interface, any type of network interface, a modem, and as any other type of communication interface. A wireless interface enables client device 600 to receive control input commands 606 and other information from an input device, such as from remote control device 608, a portable computing-based device (such as a cellular phone) 610, or from another infrared (IR), 802.11, Bluetooth, or similar RF input device.

A network interface provides a connection between client device 600 and a communication network by which other electronic and computing devices can communicate data with device 600. Similarly, a serial and/or parallel interface provides for data communication directly between client device 600 and the other electronic or computing devices. A modem facilitates client device 600 communication with other electronic and computing devices via a conventional telephone line, a DSL connection, cable, and/or other type of connection.

Client device 600 also includes one or more processors 612 (e.g., any of microprocessors, controllers, and the like) which process various computer-executable instructions to control the operation of device 600, to communicate with other electronic and computing devices, and to implement embodiments of interactive ticker. Client device 600 can be implemented with computer-readable media 614, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer-readable media 614 provides data storage mechanisms to store various information and/or data such as software applications and any other types of information and data related to operational aspects of client device 600. For example, an operating system 616 and/or other computer applications 618 can be maintained as software applications with the computer-readable media 614 and executed on processor(s) 612 to implement embodiments of an interactive ticker.

Client device 600 can also include a program guide application 620 that is implemented to process program guide data and generate program guides for display. A program guide enables a viewer to navigate through an onscreen display and locate various media content such as broadcast programs, recorded programs, video on-demand programs and movies, interactive game selections, network-based applications, and other media content of interest to the viewer. Client device 600 can also include a ticker module 622 (shown as a software module in this example) to implement various embodiments of an interactive ticker as described herein.

Client device 600 can also include a DVR system 624 with playback application 626, and recording media 628 to maintain recorded media content 630 that client device 600 receives and/or records. Further, client device 600 may access or receive additional recorded media content that is maintained with a remote data store (not shown). Client device 600 may also receive media content from a video-on-demand server, or media content that is maintained at a broadcast center or content distributor that distributes the media content to subscriber sites and client devices. The playback application 626 is a video control application that can be implemented to control the playback of media content, the recorded media content 630, and/or other video on-demand media content, music, and any other audio, video, and/or image media content which can be rendered and/or displayed for viewing.

Client device 600 also includes an audio and/or video output 632 that provides audio and/or video data to an audio rendering and/or display system 634. The audio rendering and/or display system 634 can include any devices that process, display, and/or otherwise render audio, video, and image data. Video signals and audio signals can be communicated from client device 600 to a display device 636 via an RF (radio frequency) link, S-video link, composite video link, component video link, DVI (digital video interface), analog audio connection, or other similar communication link. Alternatively, the audio rendering and/or display system 634 can be implemented as integrated components of the example client device 600. Client device 600 along with the audio rendering and/or display system 634 is an example of a viewing system that can be implemented in a household viewing area for viewing television programs and/or receiving other television media content.

FIG. 7 illustrates an example entertainment and information system 700 in which embodiments of interactive ticker can be implemented. System 700 facilitates the distribution of media content, program guide data, and advertising content to multiple viewers and to multiple viewing systems. System 700 includes a content distributor 702 and any number “N” of client systems 704(1-N) each configured for communication via a communication network 706. Each client system 704(1-N) is an example of the client systems 208(1-N) described with reference to FIG. 2. Each of the client systems 704(1-N) can receive data streams of media content, program content, program guide data, advertising content, closed captions data, and the like from content server(s) of the content distributor 702 via the communication network 706.

The communication network 706 can be implemented as any one or combination of a wide area network (e.g., the Internet), a local area network (LAN), an intranet, an IP-based network, a broadcast network, a wireless network, a Digital Subscriber Line (DSL) network infrastructure, a point-to-point coupling infrastructure, or as any other media content distribution network. Additionally, communication network 706 can be implemented using any type of network topology and any network communication protocol, and can be represented or otherwise implemented as a combination of two or more networks. A digital network can include various hardwired and/or wireless links 708(1-N), routers, gateways, and so on to facilitate communication between content distributor 702 and the client systems 704(1-N).

System 700 includes a media server 710 that receives media content from a content source 712, program guide data from a program guide source 714, and advertising content from an advertisement source 716. In an embodiment, the media server 710 represents an acquisition server that receives the audio and video media content from content source 712, an EPG server that receives the program guide data from program guide source 714, and/or an advertising management server that receives the advertising content from the advertisement source 716.

The content source 712, the program guide source 714, and the advertisement source 716 control distribution of the media content, the program guide data, and the advertising content to the media server 710 and/or to other servers. The media content, program guide data, and advertising content can be distributed via various transmission media 718, such as satellite transmission, radio frequency transmission, cable transmission, and/or via any number of other wired or wireless transmission media. In this example, media server 710 is shown as an independent component of system 700 that communicates the program content, program guide data, and advertising content to content distributor 702. In an alternate implementation, media server 710 can be implemented as a component of content distributor 702.

Content distributor 702 is representative of a headend service in a content distribution system, for example, that provides the media content, program guide data, and advertising content to multiple subscribers (e.g., the client systems 704(1-N)). The content distributor 702 can be implemented as a satellite operator, a network television operator, a cable operator, and the like to control distribution of media content, program and advertising content, such as movies, television programs, commercials, music, and other audio, video, and/or image content to the client systems 704(1-N).

Content distributor 702 includes various content distribution components 720 to facilitate media content processing and distribution, such as a subscriber manager, a device monitor, and one or more content servers. The subscriber manager manages subscriber data, and the device monitor monitors the client systems 704(1-N) (e.g., and the subscribers), and maintains monitored client state information.

Although the various managers, servers, and monitors of content distributor 702 (to include the media server 710 in one embodiment) are described as distributed, independent components of content distributor 702, any one or more of the managers, servers, and monitors can be implemented together as a multi-functional component of content distributor 702. Additionally, any one or more of the managers, servers, and monitors described with reference to system 700 can implement features and embodiments of interactive ticker.

The content distributor 702 includes communication interface(s) 722 that can be implemented as any type of interface to communicate and receive data from client devices of the television system. The content distributor 702 also includes one or more processors 724 (e.g., any of microprocessors, controllers, and the like) which process various computer-executable instructions to control the operation of content distributor 702. The content distributor 702 can be implemented with computer-readable media 726 which provides data storage to maintain software applications such as an operating system 728 and media content 730 for distribution to the client systems 704(1-N).

The client systems 704(1-N) can each be implemented to include a client device 732 and a display device 734 (e.g., a television, LCD, and the like). A client device 732 of a respective client system 704 can be implemented in any number of embodiments, such as a set-top box, a digital video recorder (DVR) and playback system, an appliance device, a gaming system, and as any other type of client device that may be implemented in an entertainment and information system. In an alternate embodiment, client system 704(N) is implemented with a computing device 736 as well as a client device. The computing device 736 is an example of a connected data store that can record and maintain media content for a client device. Additionally, any client device 732 of a respective client system 704 can implement features and embodiments of interactive ticker as described herein.

Although embodiments of an interactive ticker have been described in language specific to features and/or methods, it is to be understood that the subject of the appended claims is not necessarily limited to the specific features or methods described. Rather, the specific features and methods are disclosed as example implementations of an interactive ticker.

1. A method, comprising:
displaying an interactive ticker along with television media content that is being displayed for viewing, the interactive ticker including selectable ticker data being displayed for viewer selection; and
receiving the viewer selection to initiate one of the selectable ticker data.

2. A method as recited in claim 1, wherein the selectable ticker data includes favorite channels of the viewer, the favorite channels each being displayed as a picture-in-picture in the interactive ticker.

3. A method as recited in claim 2, wherein a picture-in-picture of a favorite channel is received as the viewer selection to initiate the favorite channel being displayed as the television media content that is rendered for viewing.

4. A method as recited in claim 1, wherein the selectable ticker data includes buddies that are associated with the viewer in a buddy list, the viewer selection being received to initiate instant messaging communication with one or more of the buddies.

5. A method as recited in claim 1, wherein the selectable ticker data includes computer applications that are selectable from the interactive ticker, the viewer selection being received to initiate a computer application for viewer interaction.

6. A method as recited in claim 1, further comprising receiving a ticker control input to configure the interactive ticker.

7. A method as recited in claim 6, wherein the ticker control input selects a type of the selectable ticker data that is displayed in the interactive ticker.

8. A method as recited in claim 6, wherein the ticker control input initiates scrolling the interactive ticker in a reverse direction.

9. A method as recited in claim 6, wherein the ticker control input initiates at least one of starting the interactive ticker, stopping the interactive ticker, turning the interactive ticker on for display, or turning the interactive ticker off.

10. An interactive ticker displayed with television media content that is being displayed for viewing, the interactive ticker comprising:
data positions each configured as a placeholder for selectable ticker data displayed in the interactive ticker; and
control inputs for configuring the interactive ticker when displayed with the television media content.

11. An interactive ticker as recited in claim 10, wherein the selectable ticker data includes favorite channels of a viewer, the data positions each having a favorite channel being displayed as a picture-in-picture in the interactive ticker.

12. An interactive ticker as recited in claim 1, wherein a picture-in-picture of a favorite channel is selectable from a data position to initiate the favorite channel being displayed for viewing.

13. An interactive ticker as recited in claim 10, wherein the selectable ticker data displayed in the interactive ticker changes according to a time of the day.

14. An interactive ticker as recited in claim 10, wherein the selectable ticker data includes recorded television media content that can be selected to initiate playback of a recording for viewing.

15. An interactive ticker as recited in claim 10, wherein the control inputs include a ticker data selection input configured to select a type of selectable ticker data that is displayed in the interactive ticker.

16. An interactive ticker as recited in claim 10, wherein the control inputs include a ticker direction input configured to initiate the interactive ticker scrolling horizontally in at least one of a left direction, a right direction, or a reverse direction.

17. An interactive ticker as recited in claim 10, wherein the control inputs include a ticker direction input configured to initiate the interactive ticker scrolling vertically in at least one of an up direction, a down direction, or a reverse direction.

18. A television client device, comprising:
a media content input configured to receive television media content for display; and
a ticker module configured to generate an interactive ticker for display with the television media content, the interactive ticker including selectable ticker data being displayed for viewer selection.

19. A television client device as recited in claim 18, wherein the selectable ticker data includes favorite channels of a viewer, the favorite channels each being displayed as a picture-in-picture in the interactive ticker.

20. A television client device as recited in claim 18, wherein a picture-in-picture of a favorite channel is selectable to initiate the favorite channel being displayed for viewing as the television media content.
